(19) United States
(12) Patent Application Publication
(10) Pub. No.: US 2003/0236348 A1
(43) Pub. Date: Dec. 25, 2003

(54) Process for preparing emulsion polymers with high purity

(76) Inventors: Peter Wendling, Leverkusen (DE); Hartmut Gobel, Langenfeld (DE); Rolf Josten, Neuss (DE); Paul Krieger, Langenfeld (DE); Hans-Rafael Winkelbach, Burscheid (DE); Hans Christian Strauch, Dormagen (DE); Werner Obrecht, Moers (DE); Jean-Pierre Lambert, Strasbourg (FR)

Correspondence Address: BAYER POLYMERS LLC, 100 BAYER ROAD, PITTSBURGH, PA, 15205, US

(21) Appl. No.: 10/447,479

(22) Filed: May 29, 2003

(30) Foreign Application Priority Data
Jun. 5, 2002 (DE) 10224886.9

(51) Int. Cl. C08J 3/00; C08K 3/00

(52) U.S. Cl. 524/801; 524/804

(57) ABSTRACT

The present invention relates to a process for preparing emulsion polymers with very high purity.

### FIELD OF THE INVENTION

The present invention relates to a process for preparing emulsion polymers with very high purity.

### BACKGROUND OF THE INVENTION

There is a need in the rubber industry for processes, which prepare emulsion polymers and permit ecological and economic procedures to be used to prepare products with good properties and very high purity.

U.S. Pat. No. 2,378,732 describes a process claimed to give rubbers with <0.5% by weight fatty acid content. This rubber is obtained via coagulation in an acidic medium, followed by washing with an alkaline solution of pH greater than about 9 or 10, but only if the resultant polymer is water-washed until the washing water is neutral. Disadvantages with this process are the poor space-time yields which it gives, associated with repeated washing to achieve neutrality, and the high consumption of washing water. This type of process is therefore not particularly economic and not particularly compatible with the environment.

It is therefore an object of the present invention to provide an ecological and economic process for preparing emulsion polymers produced with both high purity and good product quality.

### SUMMARY OF THE INVENTION

The present invention therefore is directed to a process for preparing emulsion polymers, characterized in that the latex obtained in the usual way by emulsion polymerization in the presence of fatty acid salts and/or of resin acid salts, and freed from unreacted monomers, is treated with acids in the pH range ≦6, where appropriate with addition of precipitants, and then the pH of the resultant polymer suspension is adjusted to ≧11, the resultant polymer is removed from the suspension, and is then subjected to shear until the water content is ≦20%.

### DETAILED DESCRIPTION OF THE INVENTION

The process of the present invention may be carried out continuously or batchwise. A continuous process is preferred.

The emulsion polymers, which can be prepared by the process of the present invention, are any of the emulsion polymers known to the person skilled in the art.

These include homo- and copolymers and graft polymers, and also terpolymers which can be prepared by emulsion polymerization. Examples of the repeat monomer units in the polymers are those derived from butadiene, isoprene, acrylonitrile, or styrene. Preferably, butadiene acrylonitrile and/or styrene, more preferably butadiene or acrylonitrile. There may also be other monomer units copolymerized within the polymers mentioned. For example, use may be made of acids, such as: acrylic acid, methacrylic acid, flumaric acid and/or maleic acid but also unsaturated carboxylic acid ester monomers such as methyl acrylate, ethyl acrylate, ethyl methacrylate, propyl acrylate, propyl methacrylate, butyl acrylate, butyl methacrylate, hexyl acrylate, hexyl methacrylate, cyclohexyl acrylate, cyclohexyl methacrylate, lauryl acrylate and lauryl methacrylate; and polyethylene glycol acrylate, polyethylene glycol methacrylate, polypropylene glycol acrylate, polypropylene glycol methacrylate, epoxy acrylate, epoxymethacrylate, urethane acrylate and urethane methacrylate. It is preferable to copolymerize methacrylic acid and fumaric acid. These polymers may also be in crosslinked form. This crosslinking may take place thermally, or by using any of the crosslinking agents known to the person skilled in the art. Preferred crosslinking agents are divinylbenzene and ethylene glycol dimethacrylate.

The process of the present invention provides emulsion polymers, which, as mentioned, are prepared in the usual way in the presence of emulsifiers. These emulsifiers include alkali metal salts of fatty acids and/or of resin acids. The use of the alkali metal salts of fatty acids in the preparation of polymers has long been known, as described in, Methoden der organischen Chemie “Methods of organic chemistry”, Houben-Weyl, Volume XIV/1, Makromolekulare Stoffe “Macromolecular materials”, Part 1, pp. 192-194, Georg Thieme Verlag, 1961. The chain length of the fatty acids is from 10 to 22 carbon atoms. Mono- and/or bi- or poly-unsaturated fatty acids are also suitable. The fatty acid salts may be used alone or in the form of a mixture of fatty acid salts of different chain length. If a mixture is used, the proportion of fatty acid salts having chain lengths from 16 to 18 carbon atoms should be ≧80%. If a single fatty acid salt is used, preference is given to the alkali metal salt of oleic acid.

The resin acids used are tricyclic diterpenecarboxylic acids obtained from roots, pine balsam, and tall oil. These are termed unmodified resin acids and can, for example, be converted to give disproportionated resin acids (W. Bardendrecht, L. T. Lees in Ullmanns Encyclopädie der Technischen Chemie “Ullmann's Encyclopaedia of Industrial Chemistry”, 4th edition, Vol. 12, 525-538, Verlag Chemie, Weinheim—New York 1976). Disproportionated resin acids in the form of their alkali metal salts are mainly used as emulsifiers for preparing polymers and latices (W. Bardendrecht, L. T. Lees in Ullmanns Encyclopädie der Technischen Chemie “Ullmann's Encyclopaedia of Industrial Chemistry”, 4th edition, Vol. 12, 530, Verlag Chemie, Weinheim—New York 1976). However, use is also made in some cases of the alkali metal salts of unmodified resin acids (Methoden der organischen Chemie “Methods of organic chemistry”, Houben-Weyl, Volume XIV/1, Makromolekulare Stoffe “Macromolecular materials”, Part 1, pp. 196 and 738, Georg Thieme Verlag, 1961). Unmodified resin acids and disproportionated resin acids are both suitable, in the form of their alkali metal salts, for the process of the invention. Preference is given to the alkali metal salts of disproportionated resin acids. Of course, the fatty acid salts and/or resin acid salts may also be used mixed with one another. More preference is given to fatty acid salts and mixtures of these.

Of course, the fatty acid salts and/or resin acid salts may also be used mixed with one another. Preference is given to fatty acid salts and mixtures of these.

The fatty acid salts and/or resin acid salts may also be replaced in part by sulphates or sulphonates.

The amount which can be replaced of the fatty acid salts and/or resin acid salts depends on the absolute amount used of fatty acid salts or resin acid salts, on the emulsifying quality of the sulphates and sulphonates, and also on whether the resulting latex with the precipitation aids and precipitants mentioned in the process of the present invention can be precipitated quantitatively. The amount of the fatty acid salts and/or resin acid salts which can be replaced can readily be determined by appropriate preliminary experiments.

It is preferable to use sulphonates having aliphatic and/or aromatic substituents and sulphates having aliphatic substituents. The number of commercially available sulphonates and sulphates is relatively great, and this is known to the person skilled in the art. It is also known that these are used for preparing polymers (Methoden der organischen Chemie “Methods of organic chemistry”, Houben-Weyl, Volume XIV/1, Makromolekulare Stoffe “Macromolecular materials”, Part 1, pp. 196-199 and pages 207 and 208, Georg Thieme Verlag, 1961).

The latex removed in the usual way from unreacted monomers is then treated with acids in the pH range ≦6, whereupon the latex precipitates. The treatment is preferably carried out at pH ≦4, more preferably ≦2.

The precipitation of the polymer is preferably initiated at temperature of from 20 to 110° C., preferably from 50 to 98° C., more preferably from 65 to 85° C.

For the precipitation, use may be made of any of the mineral or organic acids which are capable of setting the desired pH ranges. It is preferable to use mineral acids to set the pH. Suitable acids include hydrochloric acid, sulphuric acid, sulphurous acid, nitric acid, nitrous acid, and phosphoric acid. Sulphuric acid is preferably used.

As mentioned, use may also be made of precipitants and precipitation aids for the precipitation of the process of the invention. Examples of additional precipitants used are the known alkali metal salts of inorganic acids, and also mixtures of these. Preferred alkali metal salts, which may be used, are the sodium and potassium salts of the following acids: hydrochloric acid, sulphuric acid, sulphurous acid, nitric acid, nitrous acid, and phosphoric acid. More preference is given to the sodium and potassium salts of hydrochloric acid and sulphuric acid. Most preference is given to sodium chloride and sodium sulphate. The amount added of the precipitant is from 0.05 to 10% by weight, preferably from 0.5 to 8% by weight, more preferably from 1 to 5% by weight, based on the solids content of the latex dispersion.

In addition, the known precipitation aids may also be added during the precipitation of the latex. Suitable precipitation aids include gelatin, polyvinyl alcohol, cellulose, carboxylated cellulose and cationic or anionic polyelectrolytes, or mixtures of these. Preference is given to gelatins and cationic or anionic polyelectrolytes.

If use is made of precipitation aids, the amount preferably added of these is from 0.01 to 2% by weight, more preferably from 0.05 to 1% by weight, based on the solids content of the latex dispersion.

The preferred amount of acids, precipitant and precipitation aid may readily be determined by appropriate preliminary experiments. Good mixing of latex and precipitant is required during precipitation of the latex. This can be achieved using a nozzle through which steam with precipitant is introduced into the latex, or is achieved in a tank with good stirring.

According to the process of the present invention, the pH of the resultant polymer suspension is adjusted to ≧11 by adding an aqueous alkali metal hydroxide solution. The pH is preferably adjusted to ≧11.5. The aqueous alkali metal hydroxide solutions used are solutions of sodium hydroxide or potassium hydroxide, preferably sodium hydroxide in water with from 10 to 50% alkali metal hydroxide content.

The alkaline treatment of the coagulated polymer is preferably carried out at from 60 to 100° C., more preferably at from 65 to 95° C.

After the alkaline treatment, the polymer is removed from the suspension in the manner familiar to the person skilled in the art. Sieves, preferably vibratory sieves are used to remove the polymer.

In contrast to the processes of the prior art, the process of the present invention does not require the resultant polymer to be subjected to additional water washing.

According to the process of the present invention, the polymer removed from the suspension is subjected to shear, whereupon serum present is removed. The manner of exerting the shear here is such that the residual moisture level in the polymer is ≦20% by weight, preferably ≦10% by weight, more preferably ≦5% by weight.

The residual moisture level here is defined as follows: weight of moisture removed×100/weight of dry product.

The shear is exerted in apparatus suitable for this purpose and known to the person skilled in the art, e.g. dewatering extruders.

The dewatering extruders have barrels composed of sections with strainer zones or composed of sealed zones. The strain zones are composed of strainer bars with various gap dimensions. The screw is composed of separately mounted screw components. This means that the diameters, pitch, number of flights, and the material of the units can always be matched to the local process requirements. To separate serum and polymer, there are pressure zones with various diameters attached to the screw. There is a suitable cutting device attached to the end of the extruders, in order to convert the polymers into a form suitable for drying.

Once the abovementioned residual moisture level has been established in the polymers by appropriate shear, the polymer is then also dried in the usual way.

The process according to the present invention gives very high-purity emulsion polymers. Their emulsifier content (salts of the fatty and resin acids and/or the corresponding free acids) is ≦0.4% by weight and the concentration of monovalent cations in the emulsion polymers is ≦1000 mg, preferably ≦700 mg, more preferably ≦400 mg/kg of polymer, and the concentration of bi- and trivalent cations is ≦500 mg, preferably ≦250, more preferably ≦100 mg per kg of polymer.

### EXAMPLES

The testing of properties for the examples of the present invention and the comparative examples was carried out as follows:

The residual moisture level was determined using infrared radiation and analysis balance at 150° C. The equipment used was PM 480 analysis balance and LP 16 infrared dryer from Mettler. The starting weight of moist rubber was about 5 g. The residual moisture level is taken as constant and determined when the weight difference over a time interval of 120 seconds is less than 10 mg. Once this condition has been achieved, the equipment switches off automatically. The residual moisture level determined can be read off directly from the equipment.

The contents of the cations calcium, magnesium, sodium and potassium were determined by atomic absorption spectroscopy.

The chloride ion contents were determined using chlorine determination.

The fatty acid content (total of fatty acid and fatty acid salt) in the polymer was determined by gas chromatography. The parameters used were the following:

| | |
|---|---|
| Capillary column | Permabond FFAP-DF-0.25 m* |
| | 0.32 mm ID |
| Temperatures Injector | 240° C. |
| Detector | 240° C. |
| Oven | 220° C., isothermal |

Determination of Total Fatty Acid:

4-5 g (with accuracy to 0.01 g) of the mixture to be investigated are dissolved in 20 ml of toluene and 20 ml of THF. The solution is treated with 100 μl of H₃PO₄, and also with 5 ml of standard solution. After 1.5 h of reaction time, the solution is precipitated using 60 ml of methanol. Where appropriate, 20 ml of the extract solution are dried under nitrogen and treated with 2 ml of methanol. The solution is removed from the polymer by transfer to a new sample tube, and again dried under nitrogen. Depending on concentration, the residue is treated with 500 μl, 1000 μl or 2000 μl of toluene.

Analysis Method:

1.0 μl of the extract/standard solution is injected using automatic specimen insertion (two determinations).

The Mooney viscosity of the crude polymer was measured in accordance with DIN 53523.

The present invention is further illustrated below by examples.

### Example 1

Use was made of a stopped and stabilized, aqueous NBR latex dispersion (13% solids content) with an acrylonitrile content of 35% by weight and a butadiene content of 65% by weight, based on the polymer, and with a Mooney viscosity of 80 MU (ML1+4 at 100° C.). The latex dispersion was pumped into a precipitation nozzle at a flow rate of 15 m³/h, steam (900 kg/h) was fed in and 50% strength sulphuric acid solution 60 l/h was fed into the latex dispersion flowing at flow rate 20 m/s. The resultant coagulate was continuously dispersed in a stirred vessel (conversion vessel) which had been charged with an aqueous NaOH solution with a pH of 11.5 and a temperature of 80° C. 50% strength sodium hydroxide solution at 105 l/h and 3 m³/h of fresh water were also metered continuously into the vessel, giving a pH of 12. The alkaline suspension was passed over a vibratory sieve, thus separating the polymer crumb and the aqueous serum. The alkaline serum was pumped back into the conversion vessel at a flow rate of 35 m³/h. The moist polymer crumb was continuously transferred to a dewatering screw equipped with strainer bars and in which the residual moisture level was adjusted to 5%, based on the polymer.

Downstream of the dewatering screw, there was a rotating knife, which comminuted the product to a crumb size of from 3 to 4 mm. The crumb was then transported to a dryer and dried to a residual moisture level of <0.7%. The ion contents and fatty acid contents are listed in Table 1.

TABLE 1

| Ion analysis | | | | | | | Fatty |
|---|---|---|---|---|---|---|---|
| | | | | Cl. | S | | acid |
| Na | K | Ca | Mg | inorg. | total | Ash | content |
| mg/kg | mg/kg | mg/kg | mg/kg | % | % | % | % |
| 208 | 149 | 4 | <1 | 0.009 | 0.110 | <0.05 | 0.13 |

The analytical data for the inventive Example 1 show that very pure products are obtained when the process according to the present invention is used.

### Example 2

A stopped and stabilized, aqueous NBR latex dispersion (16.5% solids content) adjusted to an acrylonitrile content of 35% by weight, and a butadiene content of 65% by weight, based on the polymer, and to a Mooney viscosity of 30 MU (ML1+4 at 100° C.), was pumped through a pipe into a vessel at a flow rate of 8.8 m³/h. The resultant precipitation suspension was temperature-controlled to 70° C. during the process and adjusted to a pH of 3 by adding sulphuric acid. At the same time, an aqueous solution of a cationic polyelectrolyte (Superfloc C567) was metered in at 5 kg/h. The resultant coagulate was continuously transferred from the precipitation vessel by way of an overflow into a second stirred vessel, by adding sodium hydroxide solution to establish a pH of 8. The alkaline suspension was passed over a sieve, whereupon the polymer crumb and the aqueous serum were separated from one another. The moist polymer crumb was then stirred in a vessel at 90° C. and at a pH of 11.5. Polymer crumb and serum were separated from one another by a vibratory sieve. The polymer crumb was discharged from the vessel by adding 6 m³/h of water and the returned serum. A dewatering screw was first used to dewater the moist, polymeric product to a residual moisture level of 8%, and the product was comminuted by a rotating knife and then transferred to a dryer in which the polymer was dried to a residual moisture level of <0.7%. The ion contents and fatty acid contents are listed in Table 2.

TABLE 2

| Ion analysis | | | | | | | Fatty |
|---|---|---|---|---|---|---|---|
| | | | | Cl. | S | | acid |
| Na | K | Ca | Mg | inorg. | total | Ash | content |
| mg/kg | mg/kg | mg/kg | mg/kg | % | % | % | % |
| 150 | 62 | 2 | <1 | 0.011 | 0.100 | <0.05 | 0.37 |

The analytical data for the inventive Example 2 show that very pure products are obtained when the process according to the present invention is used.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing emulsion polymers comprising the steps of:
polymerizing monomers in the presence of an emulsifier, freeing the polymer obtained from unreacted monomer(s),
treating the polymer with an acid having a pH ≦6 and optionally with the addition of an additional precipitant(s),
adjusting the resulting polymer suspension to a pH ≧11,
removing the polymer from suspension, and
shearing the polymer until the residual moisture level is ≦20%.

2. The process according to claim 1, wherein the emulsifier is an alkali metal salt of a fatty acid, a resin acid or a mixture there of.

3. The process according to claim 2, wherein the fatty acid salt is an alkali metal salt of oleic acid.

4. The process according to claim 2, wherein the resin acid is an alkali metal salt of disproportionated resin acids.

5. The process according to claim 1, wherein the acid having a pH ≦6 is selected from the group consisting of hydrochloric acid, sulphuric acid, sulphurous acid, nitric acid, nitrous acid and phosphoric acid.

6. The process according to claim 1, wherein the additional precipitant(s) is an alkali metal salts of inorganic acids.

7. The process according to claim 6, wherein the additional precipitant(s) is selected from the group consisting of hydrochloric acid, sulphuric acid, sulphurous acid, nitric acid, nitrous acid, phosphoric acid or a mixture thereof.

8. The process according to claim 1, wherein the polymer is treated with acids in a pH range ≦4.

9. The process according to claim 1, wherein in that the pH of the resultant polymer suspension is adjusted to ≧11.5.

10. The process according to claim 9, wherein the pH of the polymer suspension is adjusted by adding an aqueous alkali metal hydroxide solution.

11. The process according to claim 1, wherein the process does not include water washing the resultant polymer.

12. The process according to claim 1, wherein that the polymer is subjected to shear until the residual moisture level is ≦10%.

13. The process according to claim 12, wherein that the polymer is subjected to shear until the residual moisture level is ≦5%.
